(19) United States
(12) Patent Application Publication
(10) Pub. No.: US 2012/0193830 A1
(43) Pub. Date: Aug. 2, 2012

(54) PRODUCTION METHOD FOR A FLEXIBLE CONVERTIBLE-TOP CLOTH FOR A CONVERTIBLE

(75) Inventors: REINER ARMBRUSTER, MUEHLACKER (DE); HEIDI ZINK, ILLINGEN (DE)

(73) Assignee: DR. ING. H.C. F. PORSCHE AKTIENGESELLSCHAFT, STUTTGART (DE)

(21) Appl. No.: 13/300,844

(22) Filed: Nov. 21, 2011

(30) Foreign Application Priority Data
Feb. 1, 2011 (DE) 10 2011 000 437.8

(51) Int. Cl. B28B 11/08; B29C 69/00; B29C 33/40

(52) U.S. Cl. 264/219; 264/293; 264/241

(57) ABSTRACT

A method produces a flexible convertible-top cloth for a convertible top, an outside of which convertible-top cloth is provided with a decoration. The cost-effective production method is distinguished in that use is made of a convertible-top cloth which has plastic fibers, and in that the decoration is produced on the convertible-top cloth in the form of a permanent depression deforming the plastic fibers by a stamp having a negative of the decoration. The convertible-top cloth is heated to a predetermined temperature and the stamp is pressed onto the convertible-top cloth with a predetermined force.

### CROSS-REFERENCE TO RELATED APPLICATION

This application claims the priority, under 35 U.S.C. §119, of German application DE 10 2011 000 437.8, filed Feb. 1, 2011; the prior application is herewith incorporated by reference in its entirety.

### BACKGROUND OF THE INVENTION

### Field of the Invention

The invention is based on a production method for a flexible convertible-top cloth for a convertible.

A production method of this type is known from published, non-prosecuted German patent application DE 10 2008 044 940 A1. In this case, on the convertible-top cloth, an “information carrier” is fixed on the outside of the convertible-top cloth as a decoration. In the known method, the decoration is fixed on the outside of the convertible-top cloth as a separate part, wherein fastening elements which pass through the convertible-top cloth are provided on the rear side of the information carrier. Furthermore, the document describes another production method for a convertible-top cloth, in which an information carrier is to be fixed on the outside of the convertible-top cloth by an adhesive connection.

### SUMMARY OF THE INVENTION

It is accordingly an object of the invention to provide a production method for a flexible convertible-top cloth for a convertible which overcomes the above-mentioned disadvantages of the prior art methods of this general type, which production method is cost-effective and also permits permanent decoration of the convertible-top cloth.

With the foregoing and other objects in view there is provided, in accordance with the invention a method for producing a flexible convertible-top cloth for a convertible top, an outer side of the flexible convertible-top cloth having a decoration. The method includes the steps of: forming the flexible convertible-top cloth from plastic fibers and producing the decoration on the flexible convertible-top cloth in a form of permanent depressions by deforming the plastic fibers via a stamp having a negative of the decoration. The flexible convertible-top cloth is heated to a predetermined temperature; and the stamp is pressed onto the flexible convertible-top cloth with a predetermined force.

The advantages primarily obtained with the invention are to be found in the fact that a separate information carrier is not required. In addition, in the case of the method according to the invention, the convertible-top cloth is not pierced by fastening elements, and therefore, in the case of the convertible-top cloth produced according to the invention, holes do not have to be provided in the convertible-top cloth. In addition, the convertible-top cloth produced according to the invention is permanently provided with the decoration. In the method according to the invention, use is advantageously made of a flexible convertible-top cloth which contains plastics fibers or is produced from plastics fibers. Consequently, the convertible-top cloth is configured in particular as a woven fabric, wherein at least individual threads of the woven fabric consist of the plastics fibers mentioned. In order to be able to introduce the decoration permanently into the outside of the convertible-top cloth, it is furthermore provided, according to the method according to the invention, to use a stamp which has a negative of the decoration to be introduced. The decoration is introduced with the stamp into the convertible-top cloth in the form of a permanent depression deforming the plastics fibers. This is achieved according to the invention by the convertible-top cloth being heated to a predetermined temperature and the stamp being pressed onto the convertible-top cloth with a predetermined force. In the process, the plastics fibers are permanently plastically deformed by the negative of the stamp, as a result of which the decoration is reproduced or impressed in the convertible-top cloth without the convertible-top cloth being completely pierced.

According to one exemplary embodiment, the predetermined temperature to which the convertible-top cloth is heated is particularly preferably set to approximately 70° C. to 90° C. The force with which the stamp is pressed onto the convertible-top cloth is preferably set to between 5 and 50 kN, wherein use is preferably made of approximately 7 kN for the contact pressure force of the stamp against the convertible-top cloth. The stamp is particularly preferably produced here from aluminum or will at least have aluminum at least in regions.

In a particularly preferred embodiment of the method according to the invention, the convertible-top cloth is heated by the stamp being set into a mechanical high-frequency oscillation while the stamp is pressed onto the convertible-top cloth with the predetermined force. Owing to the fact that the stamp oscillates at high frequency, the convertible-top cloth is heated to the predetermined temperature by friction between the stamp and convertible-top cloth. The decoration is impressed in the process into the outside of the convertible-top cloth in the form of a depression.

According to one exemplary embodiment, the stamp is particularly preferably set into the high-frequency oscillation approximately for 1.5 s to 3 s, in particular 2 to 2.4 s. This short time is sufficient for introducing the decoration according to the invention into the convertible-top cloth. The production method according to the invention is therefore also distinguished by a short duration.

As an alternative to the stamp which is set into a high-frequency oscillation, it is possible to heat the stamp itself to the predetermined temperature and to press the heated stamp onto the convertible-top cloth in order to produce the depression.

According to one exemplary embodiment, a sealing tape, in particular in the form of a strip, is particularly preferably applied on the inside of the convertible-top cloth and is therefore applied on the inside and behind the decoration on the convertible-top cloth. Use is preferably made for this purpose of a “Meltex tape” which can be applied on the inside of the convertible-top cloth by the action of heat. In particular, the sealing strip can be ironed onto the inside.

In a further exemplary embodiment of the method according to the invention, a multi-layered convertible-top cloth is used. In this case, the outer layer, which is provided with the decoration, will be a woven fabric made of, for example, polyacrylonitrile, on the inside of which a rubber layer, in particular formed from a synthetic rubber, is arranged. A third layer which forms the inner layer of the convertible-top cloth is preferably produced, for example, from polyester.

Other features which are considered as characteristic for the invention are set forth in the appended claims.

Although the invention is illustrated and described herein as embodied in a production method for a flexible convertible-top cloth for a convertible, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a convertible top with a convertible-top cloth which has a decoration according to the invention; and

FIG. 2 is a sectional view through the convertible-top cloth taken along the line II-II shown in FIG. 1, wherein a stamp is also schematically indicated in FIG. 2 in order to clarify the production method.

### DESCRIPTION OF THE INVENTION

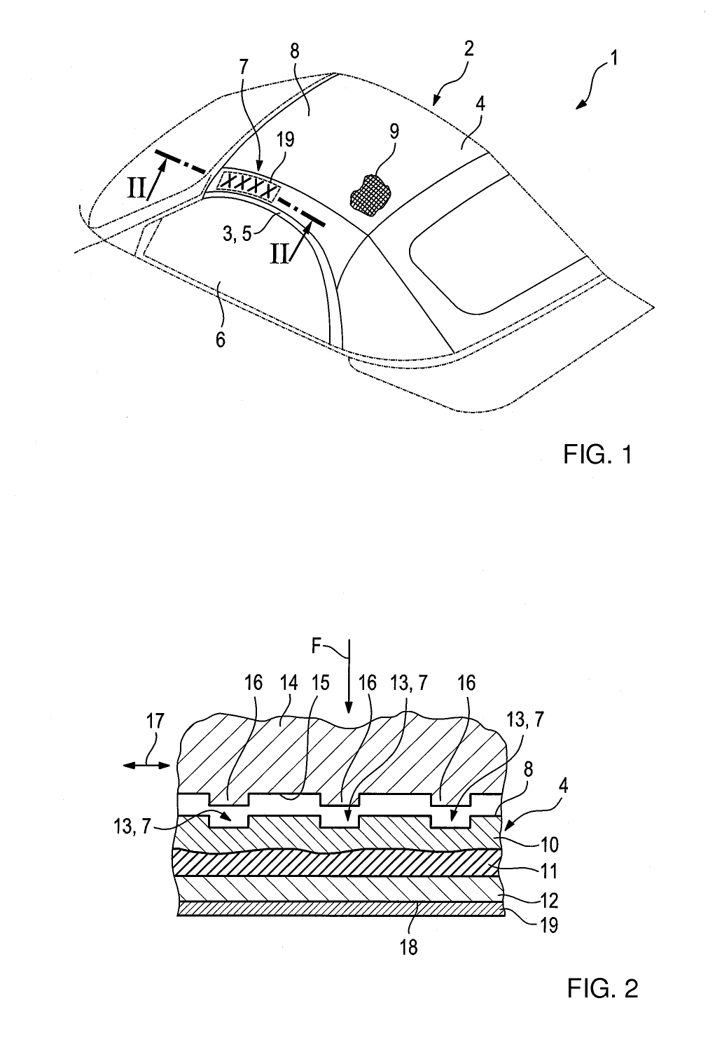

Referring now to the figures of the drawing in detail and first, particularly, to FIG. 1 thereof, there is shown a part of a convertible 1 which has a displaceable roof arrangement 2 which contains a convertible-top frame 3 which can be folded up and a flexible convertible-top cloth 4 supported by the convertible-top frame. Of the convertible-top linkage 3, the roof arrangement, which is also referred to as the convertible top 2, shows only a lateral roof frame 5 which here spans a side window 6 in an arc-shaped manner and bears a seal for the side window, wherein the seal cannot be seen. Approximately parallel to the lateral roof frame 5, the convertible-top cloth 4 has a decoration 7 which is designed, for example, as handwriting containing one or more letters and/or numbers, as an emblem or logo, as a company name or the like. The decoration 7 is introduced into the outside 8 of the convertible-top cloth, wherein the convertible-top cloth 4 is configured as a woven fabric which is produced from plastic fibers 9 which are merely indicated in FIG. 1.

It is apparent from the section according to FIG. 2 that the convertible-top cloth 4 is of multi-layered construction. An outer layer 10 having the visible outside 8 of the convertible-top cloth 4 is formed by the above-described woven fabric with the plastics fibers 9. The woven fabric layer preferably formed from the plastic fibers 9 which at least contain polyacrylonitrile. A layer 11 which is arranged thereunder and is also referred to as the intermediate layer is produced from rubber, in particular a synthetic rubber. A lower layer, which can also be referred to as the inner layer 12, is preferably a film or a woven fabric, for example containing polyester threads.

As is revealed in FIG. 2, the decoration 7 is formed by one or more depressions 13 which are introduced into the convertible-top cloth 4, and in particular into the upper layer 10, from the outside 8. The depressions 13 are introduced by the convertible-top cloth 4 or the upper layer 10 being permanently deformed. In this case, in particular the plastics fibers of the upper layer 8 are plastically deformed.

In order to be able to introduce the depressions 13 in the convertible-top cloth, a stamp 14 is provided, a lower side 15 of which has a “negative”, i.e. elevations 16, which produces the decoration 7 being the depressions 13 in the convertible-top cloth 4 when the stamp 14 is pressed onto the outside 8 of the convertible-top cloth. In the production method, the convertible-top cloth preferably rests on a non-illustrated abutment. The depressions 13 are preferably introduced into the convertible-top cloth 4 by the stamp 14 being pressed onto the outside 8 of the convertible-top cloth 4 with a force F while the stamp 14 is at the same time set by a suitable device (not shown here) into a high-frequency movement (double arrow 17) or mechanical oscillation in which the stamp 14 oscillates to and fro. The resultant friction between the outside 8 and the elevations 16 of the negative 15 of the stamp 14 generates heat which softens and melts the plastics fibers 9, and therefore the depressions 13 for the decoration 7 can be produced by the compressive force F. By use of the high-frequency oscillation of the stamp 14, the convertible-top cloth 4 is heated by the friction, for example, to a temperature of between 70° C. and 90° C. The temperature can be selected to be higher or lower corresponding to the selected plastics fibers. The same applies to the force F with which the stamp 14 is pressed onto the convertible-top cloth 4.

Before or after the decoration 7 has been introduced into the convertible-top cloth 4, a sealing tape 19 can also be applied on an inside 18 of the convertible-top cloth, and, in the case of a single-layered convertible-top cloth, correspondingly on the inside of the layer 10. Should the plastic fibers 9 be deformed, when the decoration 7 is introduced into the convertible-top cloth 4, in such a manner that tightness of the convertible-top cloth can no longer be ensured, the sealing tape 19 ensures nevertheless that moisture cannot completely penetrate the convertible-top cloth 4. The sealing tape 19 is provided only in regions, in particular in the form of a strip applied under the decoration 7, as indicated by broken lines in FIG. 1.

The depressions 13 preferably have a depth which is less than the material thickness of the layer 10. The woven fabric together with the plastic fibers 9 themselves may be single-layered or multi-layered. The depressions 13 may be provided with a color layer in order to contrast the color of the decoration 7 against the convertible-top cloth.

1. A method for producing a flexible convertible-top cloth for a convertible top, an outer side of the flexible convertible-top cloth having a decoration, which comprises the steps of:
forming the flexible convertible-top cloth from plastic fibers;
producing the decoration on the flexible convertible-top cloth in a form of permanent depressions by deforming the plastic fibers by means of a stamp having a negative of the decoration, the producing step further including:
heating the flexible convertible-top cloth to a predetermined temperature; and
pressing the stamp onto the flexible convertible-top cloth with a predetermined force.

2. The method according to claim 1, which further comprises heating the flexible convertible-top cloth to a temperature of between 70° C. and 90° C.

3. The method according to claim 1, which further comprises setting the predetermined force with which the stamp is pressed onto the flexible convertible-top cloth to be between 5 kN to 50 kN.

4. The method according to claim 1, which further comprises forming the stamp from aluminum.

5. The method according to claim 1, which further comprises heating the flexible convertible-top cloth by the stamp being set into a mechanical high-frequency oscillation while the stamp is pressed onto the flexible convertible-top cloth.

6. The method according to claim 5, which further comprises setting the stamp into the mechanical high-frequency oscillation for 1.5 s to 3 s.

7. The method according to claim 1, which further comprises heating the stamp to a further predetermined temperature.

8. The method according to claim 1, which further comprises applying a sealing tape on an inside of the flexible convertible-top cloth.

9. The method according to claim 1, which further comprises using a multi-layered convertible-top cloth.

10. The method according to claim 1, which further comprises setting the predetermined force with which the stamp is pressed onto the flexible convertible-top cloth to be 7 kN.

11. The method according to claim 5, which further comprises setting the stamp into the mechanical high-frequency oscillation for 2 s to 2.4 s.
